(19) United States
(12) Patent Application Publication
(10) Pub. No.: US 2002/0180906 A1
(43) Pub. Date: Dec. 5, 2002

(54) Method and apparatus for the reduction of LCD flicker in micropol based projection systems

(76) Inventors: Adam W. Divelbiss, Wappingers Falls, NY (US); Sadeg M. Faris, Pleasantville, NY (US)

Correspondence Address: REVEO, INC., 85 EXECUTIVE BLVD, ELMSFORD, NY, 10523, US

(21) Appl. No.: 10/140,641

(22) Filed: May 8, 2002

Related U.S. Application Data
(60) Provisional application No. 60/289,862, filed on May 9, 2001.

(51) Int. Cl. G02F 1/1335

(52) U.S. Cl. 349/104

(57) ABSTRACT

The object of the present invention is to eliminate the flicker of an LCD/Micropol assembly by reducing the excess heat caused by the attachment of the Micropol to the LCD. The present invention solves the problem of LCD flicker caused by excess heating of the LCD/Micropol assembly by reducing the amount of heat transferred to the LCD from the projection lamp. This solution is realized through the use of a special wide-band IR filter that prevents IR radiation from reaching the LCD/Micropol assembly. The IR filter used in the preferred embodiment is based on cholesterol liquid crystal reflectors that are made to reflect IR radiation back into the projection lamp. The excess heat is removed by the projection cooling system and is not transmitted to the LCD display.

### BACKGROUND OF THE INVENTION

This invention relates to stereoscopic viewing and in particular relates to a method and apparatus to reduce LCD flicker in micropolarizer based projection systems.

Lin et al. in US Pat. No. 5,682,216 describe an LCD projector (without micorpolaraizers) capable of preventing thermal shimmering by using a thermal diffusion filter. They describe an LCD projector that includes a light source assembly for supplying light required for the LCD projector; an image generating mechanism for projecting the image to be projected, having an LCD panel; a projection objective lens assembly for projecting the image generated by the image generating mechanism onto a screen; and a cooling mechanism for cooling off the surface of the LCD panel of which the temperature is raised due to the radiation of the light source. A thermal diffusion film having good transparency and thermal diffusivity is attached to the surface of the LCD panel on the side nearer to the light source assembly so as to facilitate homogeneous thermal diffusion in the surface of the LCD panel, and thus prevent deterioration of quality of the projected image due to thermal shimmering caused by the cooling air flow from the cooling mechanism.

This invention, however, addresses the flicker that often times occurs in flat panel, active matrix, LCD projections systems in which a micropolarizer (Micropol) has been mounted to enable 3D stereoscopic viewing. Specifically, the addition of the Micropol to the output side of the LCD display inside a projection system causes a significant rise in temperature of the LCD display that in turn causes an undesirable and noticeable flickering in the projected image.

Experimental results on two separate projection systems demonstrated the sharp rise in temperature of the display. In both cases the temperature on the output surface of the LCD light valve was measured and compared to the temperature measured on the output surface of a Micropol mounted to the LCD. Results indicated that the temperature nearly doubled. Temperatures measured on LCD surfaces with no Micropol installed were in the 25° C. to 28° C. range, while temperatures measured on the surface of mounted micropols were in the 48° C. to 50° C. range. The increase in temperature appears to cause a change in the responsiveness of the LCD light valve elements thereby producing the flicker.

Reducing the heat of the LCD/Micropol assembly by various methods was found to eliminate the flicker. In particular a reduction in the measured temperature on the Micropol surface from 50° C. to 42° C. was sufficient to eliminate the flicker. This proved true for both projection systems tested.

Since the number of micropols installed in projectors is very small, and since the problem has gone virtually unnoticed, there is little to no prior experience in reducing the flicker induced by a mounted Micropol. However work has been done on reducing flicker in LCD displays in general. Work done at the Hong Kong University of Science and Technology indicates that there are four potential sources for flicker in an LCD display. These four sources include: residual CD charge on the silicon surface, voltage holding ratio of the LC cell, voltage holding ratio of the silicon panel, and parasitic capacitor coupling. An article by Huang, H. C., Cheng, P. W., and Kwok, H. S. “On the Minimization of Flicker and Image Retention in Silicon Light Valves,” SID 00 Digest, pp. 248-251, (2000) is hereby incorporated by reference. Because of the nature of LC material, temperature can be an important factor in the degree to which these causes affect flicker in the display. By applying a Micropol to the surface on an LCD inside a projection system (which is a very high temperature environment by nature) the operating temperature is increased by effectively insulating the display and reducing the ability of the projectors cooling system to remove heat by convection.

Lin et al describe “LCD Projector Capable of Preventing Thermal Shimmering By Using A Thermal Diffusion Film” in U.S. Pat. No. 5,682,216, (′216) issued on Oct. 28, 1997. The ′216patent describes a thermal diffusion film having a good transparency and thermal diffusivity being attached to the LCD panel. This patent describes an LCD panel without micropols. Lin et al. teach that such a film prevents deterioration of the quality of the projected image due to shimmering caused by cooling air coming from the cooling mechanism. The ′216 patent teaches the use of a plastic film made of Tri-Acetyl Cellulose.

### SUMMARY OF THE INVENTION

The object of the present invention is to eliminate the flicker of an LCD/Micropol assembly by reducing the excess heat caused by the attachment of the Micropol to the LCD. The present invention solves the problem of LCD flicker caused by excess heating of the LCD/Micropol assembly by reducing the amount of heat transferred to the LCD from the projection lamp. This solution is realized through the use of a special wide-band IR filter that prevents IR radiation from reaching the LCD/Micropol assembly. The IR filter used in the preferred embodiment is based on cholesterol liquid crystal reflectors that are made to reflect IR radiation back into the projection lamp. The excess heat is removed by the projection cooling system and is not transmitted to the LCD display.

The present invention is an LCD projector with a micropolarizer for stereoscopic display having a light source assembly for supplying light required for said projector; an image generating mechanism for generating a stereoscopic image to be projected; a projection objective lens assembly for projecting the image generated by said image generating mechanism onto a screen; a cooling mechanism for generating cooling air flow that is made to pass through and cool off the surface of said image generating system of which the temperature is raised due to the radiation of said light source. The projector system and further micropolarizer for stereoscopic viewing and a thermal cooling subsystem containing a CLC IR filter. The CLC IR filter contains two CLC reflector sub-assemblies in which a first sub-assembly reflects left-handed circularly polarized IR radiation and in which a second sub-assembly reflects right-handed circularly polarized IR radiation. The CLC IR filter replaces any pre-existing filter/polarizer assemblies in the projection system.

### BRIEF DESCRIPTION OF THE DRAWINGS

FIG. 1 illustrates heat reduction and removal in a typical projection system;

FIG. 2 illustrates heat accumulation in a Micropol based 3D projection system;

FIG. 3 illustrates additional heat reduction due to reflection of IR radiation;

FIG. 4 illustrates a simplified method for excess heat reduction;

FIG. 5 illustrates a spectral transmission response of a typical IR filter/polarizer for a LCD projection system; and

FIG. 6 illustrates a spectral transmission response of a CLC IR reflector.

### DETAILED DESCRIPTION OF THE INVENTION

The present invention solves the problem of LCD flicker caused by excessive heating of the LCD/Micropol assembly by reducing the amount of heat transferred to the LCD from the projection lamp. This solution is realized through the use of a special wide-band IR filter that prevents IR radiation from reaching the LCD/Micropol assembly. The IR filter used in the preferred embodiment is based on cholesteric liquid crystal reflectors that are made to reflect IR radiation back into the projection lamp. The excess heat is removed by the projection cooling system and is not transmitted to the LCD display.

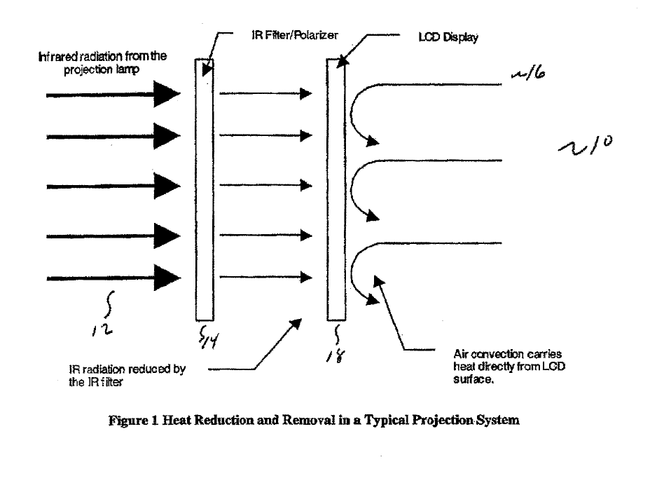

FIG. 1 illustrates the heat flow problem in a typical LCD projection system 10. In addition to the production of visible light, the high power lamp used to illuminate the projected image also produces a great amount of infrared radiation 12 that can be transmitted to the LCD light valve and converted to heat. Heating of the LCD produces many undesirable effects including image flicker, not to mention severe structural damage. Typical projection systems reduce the heat transmitted to the LCD by positioning the input polarizer away from the panel. This configuration ensures that heat absorbed by the polarizer is not directly conducted to the LCD cell. In addition, the polarizer is frequently laminated to an IR filter 14 that reduces the amount of heat absorbed by the polarizer. The filter, which is typically made using a glass substrate, provides a convenient carrier for the polarizer. Finally, a forced-air cooling system 16 is typically used to remove heat from both the polarizer and the LCD display 18 by convection. The fan system must provide sufficient air circulation for heat removal in order to keep the LCD panel within a specified operating temperature range.

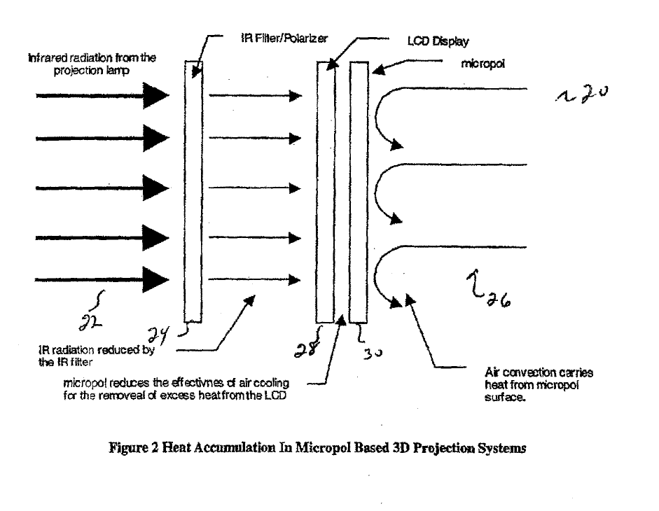

FIG. 2 illustrates how a Micropol affects the heat removal system in a 3 D stereoscopic projector 20. In this case, the IR radiation 22 received by the LCD display from the IR Filter/Polarizer 24 is the same as in the non-micropol case. However since the micropol 30 is mounted to the surface of the LCD 28, heat cannot be directly removed from the LCD surface by convection. The micropol 30 acts as an insulator and causes the LCD temperature to rise significantly resulting in poor image display performance.

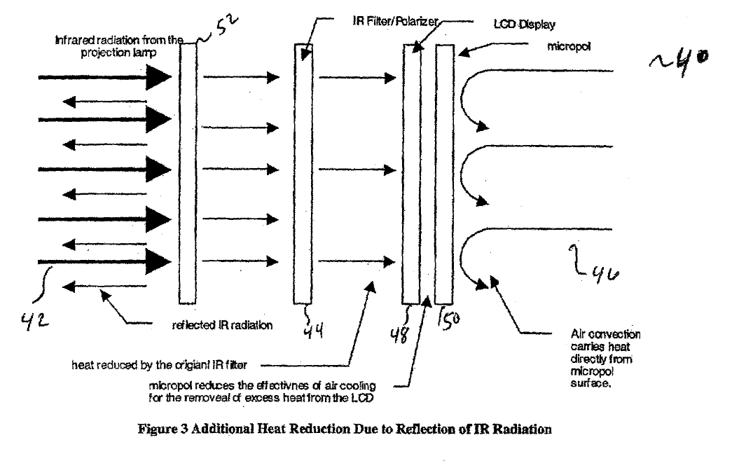

FIG. 3 illustrates the same system 40 with the addition of a CLC IR reflecting filter 52 placed prior to the original IR filter 44. In this case, lowering the amount of IR radiation transmitted by the projection lamp reduces heating of the LCD element. The reduction is accomplished through the use of a CLC IR filter that reflects a portion of the IR radiation back in to the projection lamp. CLC material typically reflects either right or left handed circularly polarized light. The filter used in this case is constructed from two filters, one to reflect left handed light and one to reflect right handed light. The CLC reflecting filters are designed in such a way as to reflect radiation in the infrared wavelength range. In addition, using a CLC based filter can improve the overall cooling system performance by eliminating IR radiation in a broader range of wavelengths than typical IR filters used in projections systems. Using a CLC reflector has another advantage in that since IR radiation is reflected rather than absorbed, the filter will not act as a source of stored heat.

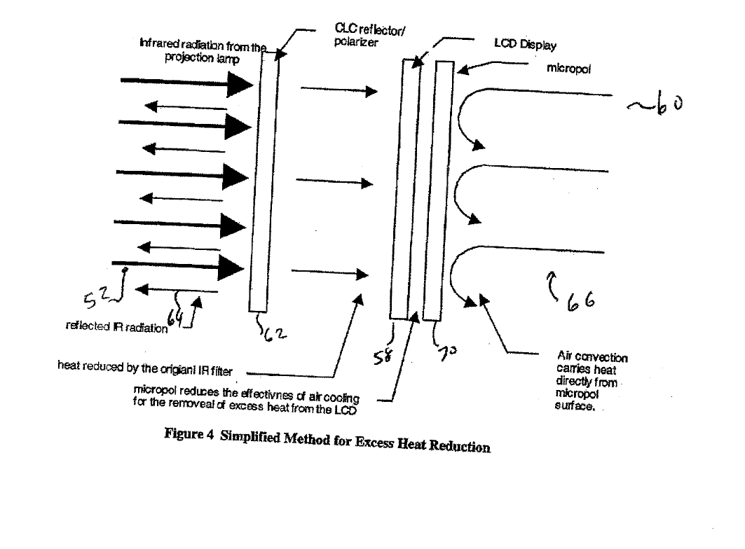

FIG. 4 illustrates an alternative to the drawing of FIG. 3 in which the original projector IR filter has been completely replaced by a CLC reflecting IR filter 62. In this case the LCD polarizer 58 has been laminated directly to the CLC filter. The heat reduction properties are the same as in the previous case. Alternatively the CLC filter can be constructed in such a way that all wavelengths of right (or left) handed circularly polarized light is reflected back into the lamp, and infrared wavelengths of left (or right) handed circularly polarized light is also reflected back into lamp. This configuration allows only left (or right) handed circularly polarized light in the visible spectrum to pass through the filter. A ¼-wave plate attached to the CLC filter (instead of a linear polarizer), then converts the left (or right) handed circularly polarized light in to linear polarized light required by the LCD display. In this case a minimally-absorptive linearly polarizing filter combined with an IR reflective filter is produced.

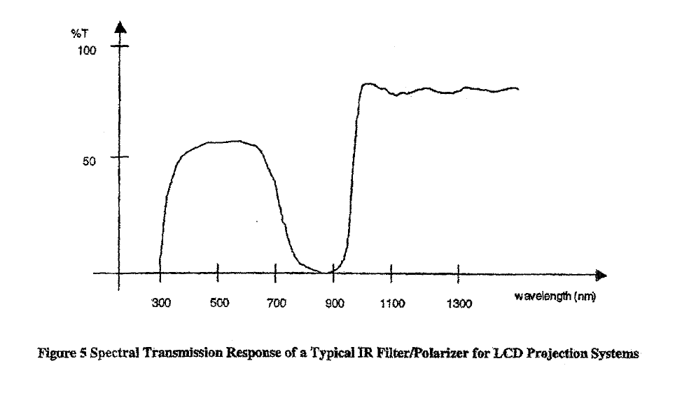

FIG. 5 illustrates the narrow-band filter response of a typical IR filter used for projectors. In this figure IR radiation is reduced in the narrow range of about 750 nm to 950 nm. IR filters with this narrow-band response may be sufficient for many projector applications. However for the special case in which a micropol is mounted to the LCD, a wider band filter will reduce the heat transferred to the LCD.

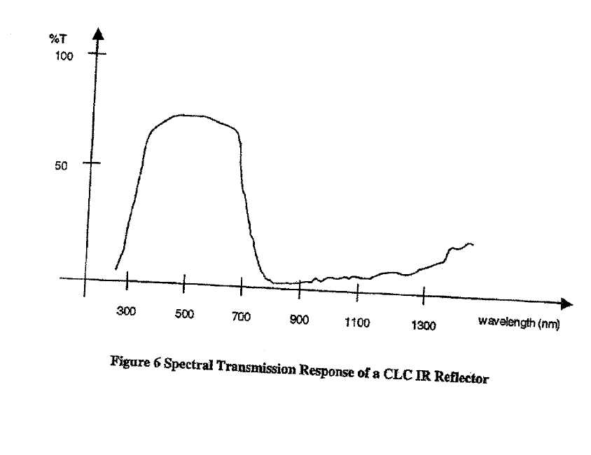

FIG. 6 illustrates the spectral response of a CLC IR reflector made using both left and right-handed CLC material. The plot shows the much wider IR blocking characteristic of the CLC filter. Eliminating a wider range of IR radiation helps to reduce the radiant heat transmitted to the LCD that results in an elimination of the flicker problem associated with micropol based projectors.

The method of accomplishing this flicker improvement can be done two different ways. A projector having an existing micro polarization device may be modified by attaching the CLC filter to the lens side of the micro polarization device. The second method is installing a combination micropolarizer-CLC filter into the LCD projector with the CLC filter mounted on the lens side of the combination device.

The present invention has been described with reference to the above illustrative embodiments. It us understood, however, modifications to the illustrative embodiments will readily occur to persons with ordinary skill in the art. All of such modifications and variations

1. A system for reducing micropol induced flicker in 3D stereoscopic projection systems comprising:
a CLC IR reflecting filter; and
a pre-existing IR blocking systems wherein said CLC IR filter reduces the overall amount of radiant heat transmitted to the display.

2. The system of claim 1 wherein said CLC IR reflecting filter is laminated with a linear polarizing film and used to replace any pre-existing filter/polarizer assemblies in the projection system.

3. The system of claim 1 wherein said CLC IR reflecting filter is constructed to pass only left handed circularly polarized light in the visible spectrum and wherein said CLC IR reflecting filter is laminated with a ¼-wave plate to convert circularly polarized light to linearly polarized light for the benefit of the LCD display and wherein said CLC IR reflecting filter is used to replace any pre-existing fitler/polarizer assemblies in the projection system.

4. The system of claim 1 wherein said CLC IR reflecting filter is constructed to pass only right handed circularly polarized light in the visible spectrum and wherein said CLC IR reflecting filter is laminated with a ¼-wave plate to convert circularly polarized light to linearly polarized light for the benefit of the LCD display and wherein said CLC IR reflecting filter is used to replace any pre-existing fitler/polarizer assemblies in the projection system.

5. The system of claim 1 wherein said CLC IR reflecting filter used to reduce the overall amount of radiant heat transmitted to the display is constructed using two CLC reflector subassemblies in which the first sub-assembly reflects left-handed circularly polarized IR radiation and in which the second sub-assembly reflects right-handed circularly polarized IR radiation.

6. The system of claim 1 wherein said CLC IR reflecting filter is constructed using a single filter sub-assembly that reflects left-handed circularly polarized IR radiation.

7. The system of claim 1 wherein said CLC IR reflecting filter is constructed using a single filter sub-assembly that reflects right-handed circularly polarized IR radiation.

8. The system of claim 1 wherein a CLC IR reflecting filter is constructed to reflect a wide band of IR radiation.

9. The system of claim 1 wherein a CLC IR reflecting filter is used in conjunction with a forced air cooling system with greater air throughput for removal of more heat from the micropol surface.

10. An LCD projector with a micropolarizer for stereoscopic display comprising:
a light source assembly for supplying light required for said projector;
an image generating mechanism for generating a stereoscopic image to be projected;
a projection objective lens assembly for projecting the image generated by said image generating mechanism onto a screen;
a micropolarizer for stereoscopic display of said image;
a cooling mechanism for generating cooling air flow that is made to pass through and cool off the surface of said image generating system of which the temperature is raised due to the radiation of said light source and further comprising:
a thermal cooling subsystem comprising an CLC IR filter.

11. The projector of claim 10 wherein said CLC IR filter comprises:
two CLC reflector sub-assemblies in which a first sub-assembly reflects left-handed circularly polarized IR radiation and in which a second sub-assembly reflects right-handed circularly polarized IR radiation.

12. The projector of claim 10 wherein said CLC IR filter replaces any pre-existing filter/polarizer assemblies in the projection system.
